(19) United States
(12) Patent Application Publication
(10) Pub. No.: US 2024/0231434 A1
(43) Pub. Date: Jul. 11, 2024

(54) ELECTRONIC DEVICE

(71) Applicant: Samsung Electronics Co., Ltd., Suwon-si (KR)

(72) Inventor: Yuanshui ZHANG, Suzhou Industrial Park (CN)

(73) Assignee: Samsung Electronics Co., Ltd., Suwon-si (KR)

(21) Appl. No.: 18/394,845

(22) Filed: Dec. 22, 2023

(30) Foreign Application Priority Data
Jan. 6, 2023 (CN) 202310018012.6

(51) Int. Cl. G06F 1/16

(52) U.S. Cl. CPC G06F 1/1647; G06F 1/1601; G06F 1/166; G06F 2200/1631

(57) ABSTRACT

An electronic device may include a frame supporting a first display panel, a second display panel, and a third display panel; and an expansion mechanism connected to the frame, and configured to drive the first display panel and the second display panel to move in a first direction, such that the first display panel, the second display panel and the third display panel switch between a screen stacking state and a screen tiling state. In the screen tiling state, the first to third display panels may be arranged side by side in the first direction and the third display panel may be under the first and second display panels. In the screen stacking state, the first to third display panels may be stacked in a second direction.

### CROSS-REFERENCE TO RELATED APPLICATION(S)

This application claims benefit of priority to Chinese Patent Application No. 202310018012.6, filed on Jan. 6, 2023 in the Chinese Intellectual Property Office, the disclosure of which is incorporated herein by reference in its entirety.

### TECHNICAL FIELD

The present disclosure relates to an electronic device, and more particularly, to an electronic device capable of expanding a screen.

### BACKGROUND

At present, screen expansion methods for electronic devices may include using flexible screens to achieve single-screen folding, scrolling, and telescopic features. However, present screen expansion methods may be highly dependent on an application of flexible screens and may have a high cost.

### SUMMARY

Example embodiments relate to an electronic device for expanding a screen that can bypass the dependence and development restrictions of flexible screens.

According to an example embodiment, an electronic device may include a first display panel; a second display panel; a third display panel; a frame, the frame supporting the first display panel, the second display panel, and the third display panel; and an expansion mechanism, the expansion mechanism connected to the frame. The expansion mechanism may be configured to drive the first display panel and the second display panel to move in a first direction, such that the first display panel, the second display panel and the third display panel switch between a screen stacking state and a screen tiling state. In the screen tiling state, the first display panel, the second display panel, and the third display panel may be arranged side by side in the first direction and the third display panel may be between the first display panel and the second display panel. In the screen stacking state, the first display panel, the second display panel, and the third display panel may be stacked in a second direction different from the first direction. The expansion mechanism may be configured to control the first display panel, the second display panel, and the third display panel to switch between the screen stacking state and the screen tiling state.

In some embodiments, the first direction may correspond to a width direction of the first display panel or a length direction of the first display panel, the second display panel, and the third display panel, and the second direction may correspond to a thickness direction of the first display panel, the second display panel, and the third display panel.

In some embodiments, the frame may include a base frame. The base frame may support the first display panel, the second display panel, the third display panel and the expansion mechanism. The base frame may slidably support the first display panel and the second display panel such that the first display panel and the second display panel may be able to be moved in the first direction. The base frame may be configured to provide fixed support to the third display panel such that a position of the third display panel relative to the base frame remains unchanged when the first display panel, the second display panel, and the third display panel switch between the screen stacking state and the screen tiling state.

In some embodiments, the frame may further include a side frame. The side frame may be mounted on the base frame. The first display panel and the second display panel may be fixed to the side frame.

In some embodiments, the base frame may include a guide groove, and the side frame may be embedded in the guide groove such that the first display panel and the second display panel, which may be fixed to the side frame, may be configured to be moved in the first direction under a guidance of the guide groove.

In some embodiments, the expansion mechanism may include a guide rail, a plurality of sliders, a plurality of connecting rods, and a motor. The guide rail may be on a back of the third display panel. The guide rail may extend in a third direction. The third direction may be perpendicular to the first direction and the second direction. The plurality of sliders may be in the guide rail and configured to be able to slide along the guide rail. The plurality of connecting rods may connect the first display panel and the second display panel to the plurality of sliders. The motor may be configured to supply power. When the plurality of sliders slide along the guide rail in response to the power supplied by the motor, the first display panel and the second display panel may move in reverse with each other in the first direction.

In some embodiments, the plurality of sliders may include a first slider and a second slider. The plurality of connecting rods may include a first connecting rod, a second connecting rod, a third connecting rod, and a fourth connecting rod. The first connecting rod may be between the first display panel and the first slider. The second connecting rod may be between the second display panel and the first slider. The third connecting rod may be between the first display panel and the second slider. The fourth connecting rod may be between the second display panel and the second slider.

In some embodiments, the motor may be configured to supply power to the first slider and the second slider to move the first slider and the second slider away from each other. When the motor moves the first slider and the second slider away from each other, the first display panel and the second display panel may move in reverse to each other in the first direction and away from the third display panel, such that an overlap area of the first display panel, the second display panel, and the third display panel in the second direction may be reduced. The motor may be configured to supply the power to the first slider and the second slider to move the first slider and the second slider close to each other. When the motor moves the first slider and the second slider close to each other, the first display panel and the second display panel may move in reverse to each other in the first direction and may be close to the third display panel, such that the overlap area increases among the first display panel, the second display panel, and the third display panel in the second direction.

In some embodiments, the motor may be a linear motor. The linear motor may be fixed to the frame. An output end of the linear motor may be connected to the plurality of sliders to supply the power to the plurality of sliders.

In some embodiments, in the screen tiling state, the first display panel, the second display panel and the third display panel may be configured to synergistically display different areas of an image. In the screen stacking state, one of the first display panel, the second display panel, and the third display panel may be configured to display the image alone. A remaining two of the first display panel, the second display panel and the third display panel may be configured not to display the image.

In some embodiments, in the screen stacking state, the first display panel, the second display panel, and the third display panel may be configured to synergistically display different partial source information of the image at full resolution and full color by means of dividing layers or color gradation. The first display panel, the second display panel, and the third display panel may be configured to perform asynchronous processing on at least one of pixels and refresh rates of the first display panel, the second display panel, and the third display panel in temporal or spatially scale, and an uppermost two display panels in the first display panel, the second display panel, and the third display panel may be transparent display panels.

Compared with a screen expansion method of electronic devices that currently use flexible screens to achieve folding screens, scrolling screens, telescopic screens, etc., a screen expansion method according to example embodiments can achieve screen expansion by using conventional screens, which may reduce the dependence on flexible screen materials and technologies, may reduce costs, and may enhance the display effect.

### BRIEF DESCRIPTION OF THE DRAWINGS

The above and other aspects of the present disclosure will become apparent and more easily understood by the following detailed description in conjunction with the accompanying drawings.

FIG. 1 is a block diagram showing an electronic device according to an example embodiment.

FIG. 2 is a block diagram showing a frame of an electronic device according to an example embodiment.

FIG. 3 is a detailed diagram showing a frame of an electronic device according to an example embodiment.

FIG. 4 is a block diagram showing an expansion mechanism of an electronic device according to an example embodiment.

FIGS. 5-7 are detailed diagrams showing an expansion mechanism of an electronic device according to an example embodiment.

FIG. 8 is a diagram showing a first display mode of an electronic device according to an example embodiment.

FIG. 9 is a diagram showing a second display mode of an electronic device according to an example embodiment.

FIG. 10 is a diagram showing a third display mode of an electronic device according to an example embodiment.

Throughout the drawings and the detailed description, the same figure reference numerals will be understood to refer to the same elements, features and structures unless described or provided otherwise. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all example embodiments are not limited thereto.

Example embodiments will be described below in detail with reference to the accompanying drawings.

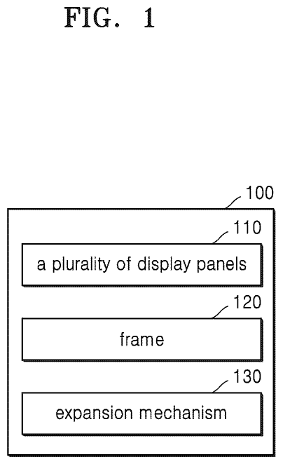

FIG. 1 is a block diagram showing an electronic device 100 according to an example embodiment.

Referring to FIG. 1, according to example embodiment, the electronic device 100 includes a plurality of display panels 110, a frame 120, and an expansion mechanism 130.

The plurality of display panels 110 may include a first display panel, a second display panel, and a third display panel for displaying an image. In one example, any one of the plurality of display panels 110 may include an organic light-emitting diode (OLED) display panel or a liquid crystal display (LCD) display panel. However, it should be understood that the present application is not limited thereto, for example, any one of the plurality of display panels 110 may include any type of display panel. In addition, in one example, the plurality of display panels 110 may include the same type of display panel, and in another example, the plurality of display panels 110 may include different types of display panels. For brevity, example embodiments may take a plurality of display panels including three display panels (e.g., the first display panel, the second display panel and the third display panel) as an example to describe embodiments of inventive concepts. However, although the present application takes the plurality of display panels 110 including three display panels as an example to describe example embodiments, the present application is not limited thereto, for example, the plurality of display panels 110 may include two display panels, or include four or more display panels.

The frame 120 may support a first display panel, a second display panel and a third display panel. In one example, the frame 120 may also support the components of the electronic device 100. For example, the frame 120 may also support the expansion mechanism 130.

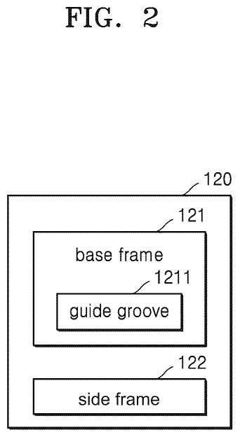

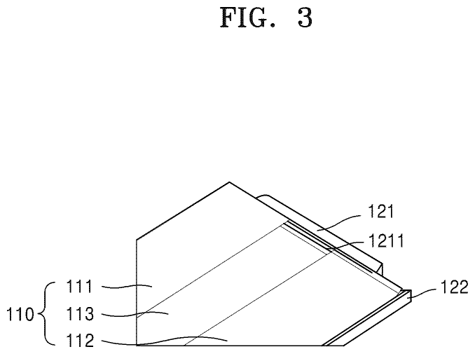

Hereinafter, the frame 120 will be described in detail with reference to FIGS. 2 and 3.

The expansion mechanism 130 may be connected to the frame 120, and may be configured to drive the first display panel and the second display panel to move in the first direction X, such that the first display panel, the second display panel and the third display panel switch between a screen stacking state and a screen tiling state.

In one example, a portion of the expansion mechanism 130 may be fixed to the frame 120, and another portion of the expansion mechanism 130 may be connected to the plurality of display panels 110.

In one example, the first direction X may correspond to a width or length direction of the first display panel, the second display panel, and the third display panel, and the second direction Y may correspond to a thickness direction of the first display panel, the second display panel, and the third display panel. That is, the first direction X may correspond to a width or length direction of each of the plurality of display panels 110, and the second direction Y may correspond to a thickness direction of each of the plurality of display panels 110. Therefore, the first direction X may be perpendicular to the second direction Y.

In one example, in the screen tiling state, the first display panel, the second display panel, and the third display panel may be arranged side by side in the first direction X and the third display panel may be located between the first display panel and the second display panel. That is, in the screen tiling state, the plurality of display panels 110 may be arranged side by side in the first direction X, and the third display panel may be located between the first display panel and the second display panel in the first direction X. In addition, in one example, in the screen stacking state, the first display panel, the second display panel and the third display panel can be stacked in the second direction Y. That is, in the screen stacking state, the plurality of display panels 110 can be stacked in the second direction Y.

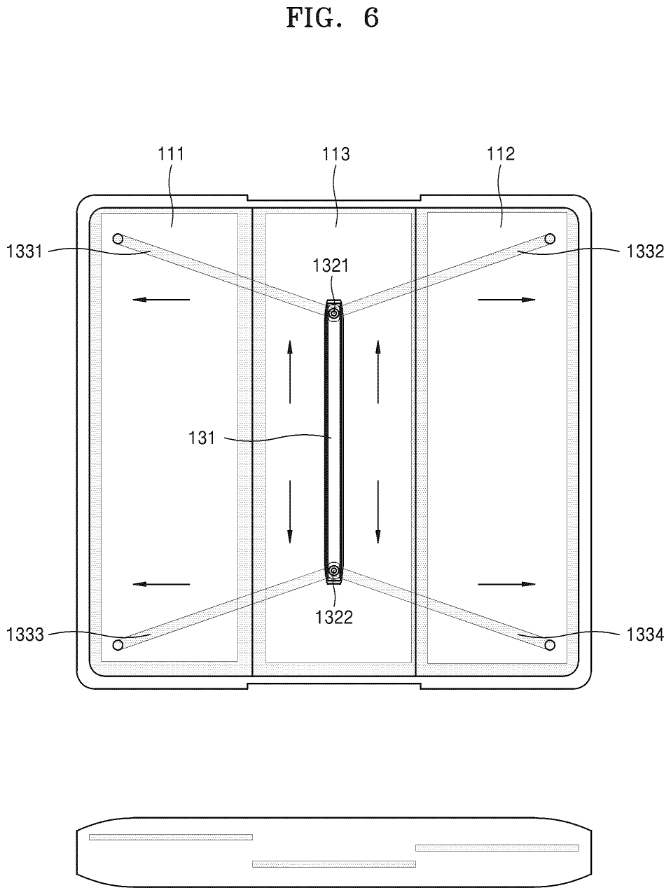

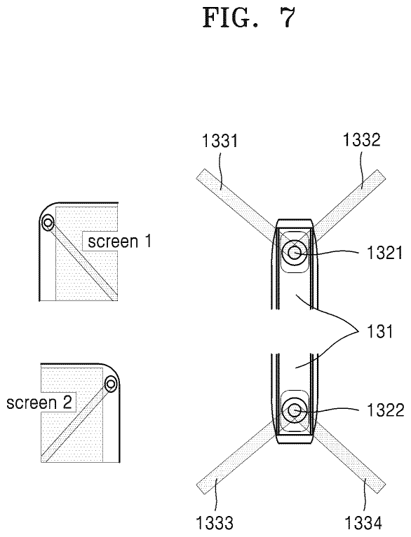

Hereinafter, the expansion mechanism 130 will be described in detail with reference to FIGS. 2 to 7.

According to example embodiment, the expansion mechanism 130 can be controlled such that the first display panel, the second display panel and the third display panel switch between the screen stacking state and the screen tiling state. In one example, the expansion mechanism 130 may be controlled in a wired or wireless manner, and may be provided with various control signals for switching the plurality of display panels 110 to the screen stacking state or screen tiling state of according to a preset program or user instructions.

The screen expansion method according to example embodiments can achieve screen expansion by utilizing a conventional screen, and thus reducing the dependence on materials and technologies of a flexible screen, reducing costs, and enhancing the display effect.

FIG. 2 is a block diagram showing the frame 120 of the electronic device 100 according to an example embodiment. FIG. 3 is a detailed diagram showing the frame 120 of an electronic device according to an example embodiment.

Referring to FIGS. 2 and 3, according to example embodiment, the frame 120 may include a base frame 121. The base frame 121 may support the first display panel, the second display panel, the third display panel and the expansion mechanism 130. That is, the base frame 121 can support the plurality of display panels 110 and the expansion mechanism 130. In one example, the base frame 121 may slidably support the first display panel and the second display panel, such that the first display panel and the second display panel can be moved in the first direction X. That is, the base frame 121 may slidably support one or more display panels among the plurality of display panels 110 that can be moved in the first direction X. In addition, in this example, the base frame 121 may fixedly support the third display panel, such that when the first display panel, the second display panel and the third display panel switch between the screen stacking state and the screen tiling state, the position of the third display panel with respect to the base frame 121 remains unchanged. That is, the base frame 121 may fixedly support one or more display panels among the plurality of display panels 110 that cannot be moved in the first direction X.

According to example embodiment, the frame 120 may also include a side frame 122. The side frame 122 can be mounted on the base frame 121. In one example, the first display panel and the second display panel can be fixed to the side frame 122. That is, the sliding connection between one or more display panels among the plurality of display panels 110 that can be moved in the first direction X and the base frame 121 can be achieved by fixing the one or more display panels among the plurality of display panels 110 that can be moved in the first direction X to the side frame 122 mounted on the base frame 121.

In one example, the base frame 121 may include a guide groove 1211. In this case, the side frame 122 may be embedded in the guide groove 1211, such that the first display panel 111 and the second display panel 112 fixed to the side frame 122 move in the first direction X under a guidance of the guide groove 1211. That is, the side frame 122 can achieve a sliding connection between the side frame 122 and the base frame 121 through the guide groove 1211 included in the base frame 121. Therefore, the sliding connection between the one or more display panels among the plurality of display panels 110 that can be moved in the first direction X and the base frame 121 can be achieved by the sliding connection of the guide groove 1211 between the side frame 122 and the base frame 121.

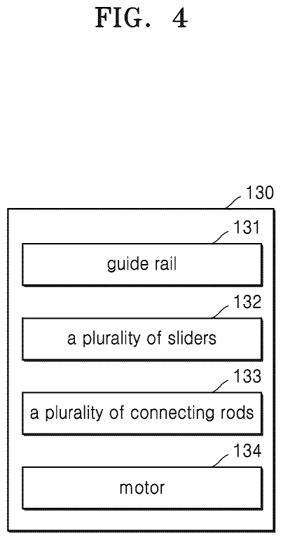

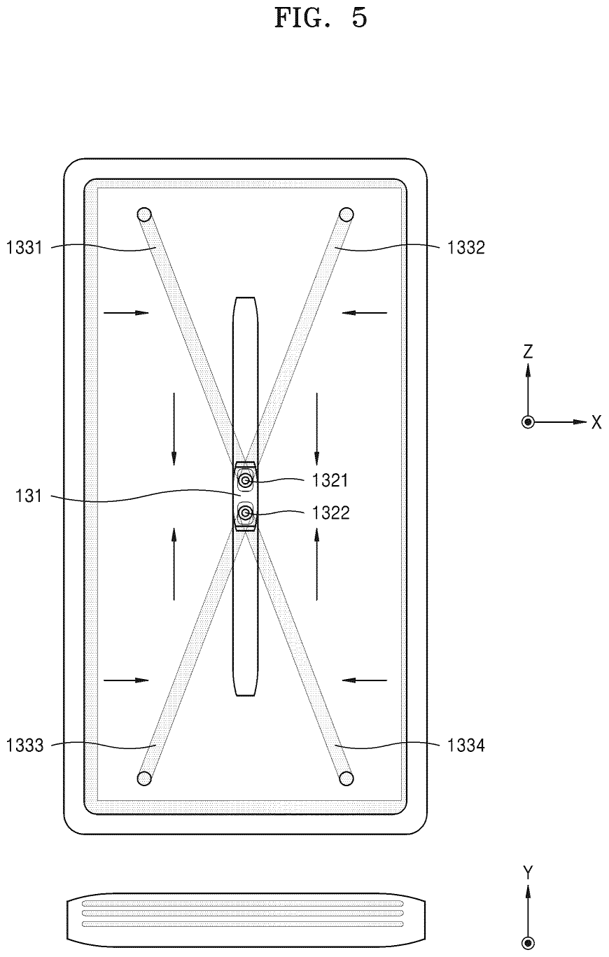

FIG. 4 is a block diagram showing the expansion mechanism 130 of the electronic device 100 according to an example embodiment. FIGS. 5-7 are detailed diagrams showing the expansion mechanism 130 of the electronic device 100 according to an example embodiment.

Referring to FIG. 4, according to example embodiment, the expansion mechanism 130 may include a guide rail 131, a plurality of sliders 132, a plurality of connecting rods 133 and a motor 134.

The guide rail 131 may be provided on a back of the third display panel. In one example, the guide rail 131 may be fixed on the frame 120 (for example, the base frame 121). In addition, the guide rail 131 may extend in a third direction Z perpendicular to the first direction X and the second direction Y. For example, in one example, when the first direction X corresponds to the length direction of the plurality of display panels, the third direction Z may correspond to the width direction of the plurality of display panels. In another example, when the first direction X corresponds to the width direction of the plurality of display panels, the third direction Z may correspond to the length direction of the plurality of display panels.

A plurality of sliders 132 may be provided in the guide rail 131, and may be configured to be able to slide along the guide rail 131. Since the guide rail 131 may extend in a third direction Z perpendicular to the first direction X and the second direction Y, a plurality of sliders 132 slide in the third direction Z perpendicular to the first direction X and the second direction Y. For example, in one example, when the first direction X corresponds to the length direction of the plurality of display panels, the third direction Z may correspond to the width direction of the plurality of display panels, and a plurality of sliders 132 may slide along the width direction of the plurality of display panels. In another example, when the first direction X corresponds to the width direction of the plurality of display panels, the third direction Z may correspond to the length direction of the plurality of display panels, and the plurality of sliders 132 may slide along the length direction of the plurality of display panels.

The plurality of connecting rods 133 can be used to connect the first display panel and the second display panel to the plurality of sliders 132. In one example, the first display panel and the second display panel may include a non-display area. In this case, the plurality of connecting rods 133 may connect the first display panel and the second display panel to the plurality of sliders 132 by connecting to the non-display area of the first display panel and the second display panel.

The motor 134 may be configured to supply power. In one example, the motor 134 may be a linear motor or a Computerized Numerical Control (CNC) motor. For example, the motor 134 may be controlled in a wired or wireless manner, and may be provided with various control signals for switching the plurality of display panels 110 to the screen stacking state or the screen tiling state according to a preset program or user instructions. In this case, the linear motor can be fixed to the frame 120 (for example, the base frame 121), and an output end of the linear motor can be connected to the plurality of sliders 132 to provide the power to the plurality of sliders 132. For example, in one example, when the plurality of sliders 132 slide along the guide rail 131 through the power supplied by the motor 134, the first display panel and the second display panel may move in reverse with each other in the first direction X.

Referring to FIGS. 5-7, in one example, the plurality of sliders 132 may include a first slider 1321 and a second slider 1322, and the plurality of connecting rods 133 may include a first connecting rod 1331, a second connecting rod 1332, a third connecting rod 1333 and a fourth connecting rod 1334. In this case, the first connecting rod 1331 may be provided between the first display panel 111 and the first slider 1321, the second connecting rod 1332 may be provided between the second display panel 112 and the first slider 1321, the third connecting rod 1333 may be provided between the first display panel 111 and the second slider 1322, and the fourth connecting rod 1334 may be provided between the second display panel 112 and the second slider 1322. In one example, through the above connection structure, when the first slider 1321 and the second slider 1322 are away from each other through the power supplied by the motor 134, the first display panel 111 and the second display panel 112 may move in reverse with each other in the first direction X and be away from the third display panel 113, such that an overlap area of the first display panel 111, the second display panel 112 and the third display panel 113 in the second direction Y may be reduced. When the first slider 1321 and the second slider 1322 are close to each other through the power supplied by the motor 134, the first display panel 111 and the second display panel 112 may move in reverse to each other in the first direction X and be close to the third display panel 113, such that the overlap area of the first display panel 111, the second display panel 112 and the third display panel 113 in the second direction Y may be increased. The sliders 1321 and 1322 may be plastic structures, which may have polygonal (e.g., rectangular) shapes and may have rounded corners, and may be attached to the guide rail 131 so the sliders 1321 and 1322 can slide along the guide rail 131.

Although FIGS. 5 to 7 show the plurality of sliders 132 may include the first slider 1321 and the second slider 1322 and the plurality of connecting rods 133 that may include the first connecting rod 1331, the second connecting rod 1332, the third connecting rod 1333 and the fourth connecting rod 1334 as an example to describe the connection relationship between the plurality of sliders 132 and the plurality of connecting rods 133, example embodiments are not limited thereto. For example, the plurality of sliders 132 may include three or more sliders, and the plurality of connecting rods 133 may include less than four connecting rods or greater than four connecting rods. In addition, although an example in which when the first slider 1321 and the second slider 1322 are away from each other, the first display panel 111 and the second display panel 112 may be away from the third display panel 113 and when the first slider 1321 and the second slider 1322 are close to each other, the first display panel 111 and the second display panel 112 may be close to the third display panel 113 is described referring to FIGS. 5-7, but example embodiments are not limited thereto. For example, in another example, through other connection structures, when the first slider 1321 and the second slider 1322 is close to each other through the power supplied by the motor 134, the first display panel 111 and the second display panel 112 may move in reverse to each other in the first direction X and be close to the third display panel 113, such that the overlap area of the first display panel 111, the second display panel 112 and the third display panel 113 in the second direction Y may be increased; when the first slider 1321 and the second slider 1322 are away from each other through the power supplied by the motor 134, the first display panel 111 and the second display panel 112 may move in reverse to each other in the first direction X and be away from the third display panel 113, such that the overlap area of the first display panel 111, the second display panel 112 and the third display panel 113 in the second direction Y can be reduced. In some embodiments, the motor 134 may move the first slider 1321 and the second slider 1322 close to each other or away from each other based on reversing a polarity of power supplied to the first slider 132 and the second slider 1322, but example embodiments are not limited thereto. The motor 134 may be electrically connected to the first slider 1321 and the second slider 1322 thorough conductive elements, such as metal contacts or wires, but example embodiments are not limited thereto.

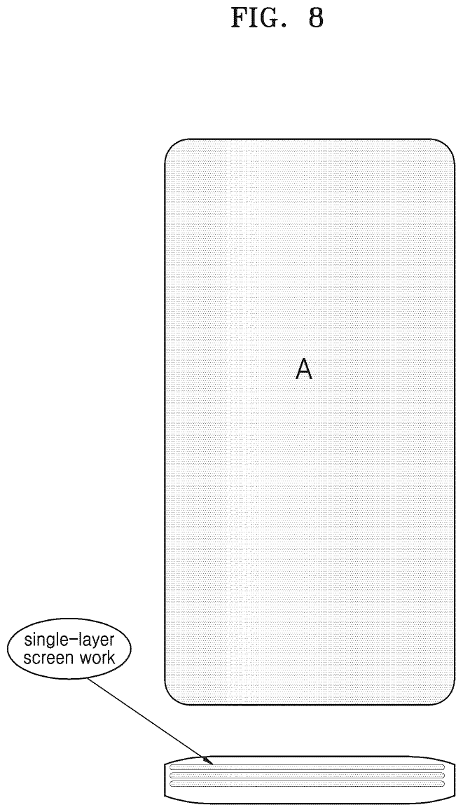

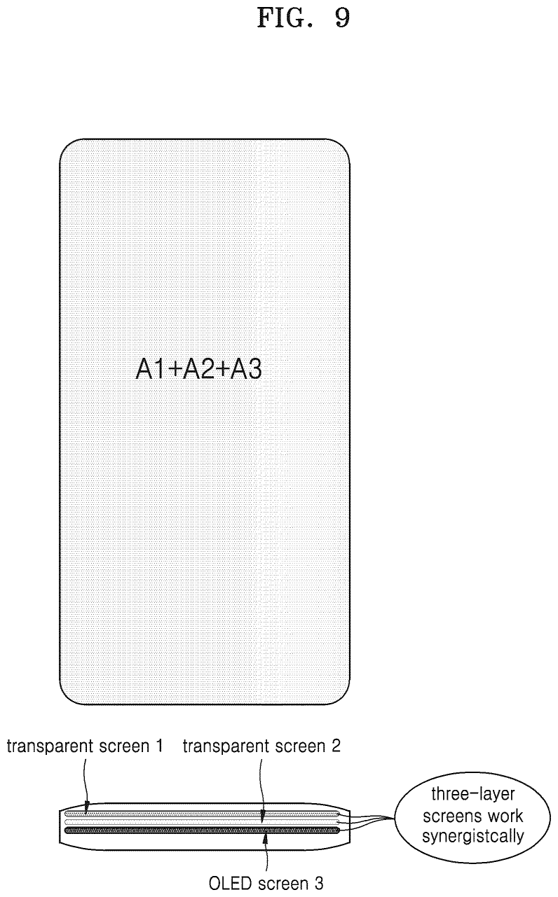

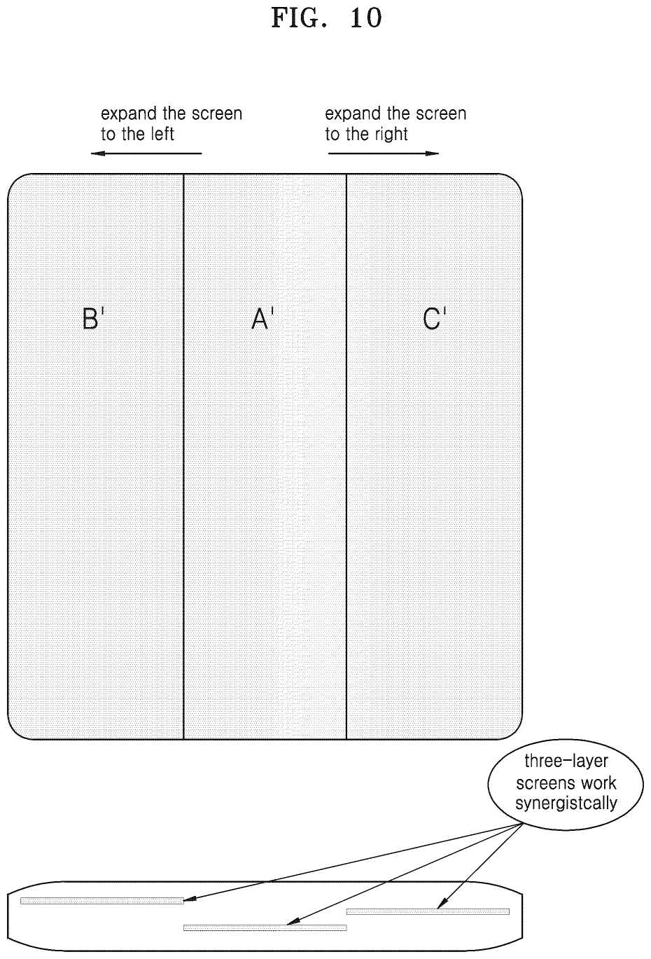

FIG. 8 is a diagram showing a first display mode of an electronic device 100 according to an example embodiment. FIG. 9 is a diagram showing a second display mode of an electronic device 100 according to an example embodiment. FIG. 10 is a diagram showing a third display mode of an electronic device 100 according to an example embodiment.

According to example embodiment, the electronic device 100 may have a plurality of display modes. The plurality of display modes may include a first display mode, a second display mode and a third display mode. When the electronic device 100 is in the screen stacking state, the first display mode or the second display mode can be enabled. Referring to FIG. 8, for the first display mode, in the screen stacking state, one of the first display panel, the second display panel and the third display panel can be configured to display an image alone, and the remaining two of the first display panel, the second display panel and the third display panel can be configured not to display the image. For example, in one example, for the first display mode, in the screen stacking state, the uppermost display panel in the plurality of stacked display panels can be configured to display the image alone (single-screen operation), and the remaining one or more display panels in the plurality of stacked display panels can be configured not to display the image or to be in a closed state to meet conventional display, effectively reducing power consumption.

In another example, for the first display mode, in the screen stacking state, a designated display panel in the plurality of stacked display panels can be configured to display the image alone, and the display panel stacked above the designated display panel can be configured as a transparent display panel, so that the designated display panel can display the image alone through the transparent display panel stacked above. The first display panel, the second display panel and the third display panel are independently connected to the display chip at the same time. In the first display mode, a single display panel works, and the display chip outputs conventional image information A to the single display panel for display, and the other two display panels do not work. Therefore, the first display mode can be called the normal display mode.

Referring to FIG. 9, for the second display mode, in the screen stacking state, the first display panel, the second display panel and the third display panel can be configured to synergistically display different partial source information of the image at full resolution and full color by means of dividing layers or color gradation, the first display panel, the second display panel and the third display panel are configured to perform asynchronous processing on pixels and/or refresh rates of the first display panel, the second display panel, and the third display panel in temporal or spatially scale, and uppermost two display panels in the first display panel, the second display panel, and the third display panel are transparent display panels. For example, the first display panel may be a transparent screen 1 in FIG. 9, the second display panel may be a transparent screen 2 in FIG. 9, the third display panel may be an OLED screen 3 in FIG. 9, and the first display panel, the second display panel and the third display panel work synergistically under a drive of one display chip, and display more original data from the display chip by means of dividing layers or color gradation to display as much image detail as possible, as well as color fullness and fineness, so as to superimpose the display effect and improve the display detail. However, it should be understood that although FIG. 9 takes the first display panel and the second display panel being transparent screens and the third display panel being located below the first display panel and the second display panel as an example to describe, but example embodiments are not limited thereto. For example, the third display panel may be located above the first display panel and the second display panel or between the first display panel and the second display panel, and the top two display panels in the first display panel, the second display panel and the third display panel may be transparent screens. The first display panel, the second display panel and the third display panel work synergistically, and the display chip outputs the original image deep layer-level information A1, A2 and A3 to the first display panel, the second display panel and the third display pane by an algorithm process, respectively. Because a sum of the image information contained in the first display panel, the second display panel and the third display panel (A1+A2+A3) is much greater than the conventional image information A, the fineness, resolution, and color quality saturation of the display are greatly improved, thereby enhancing the display effect. Therefore, the second display mode can be called enhanced display mode.

When the electronic device 100 is in the screen tiling state, the third display mode can be enabled. Referring to FIG. 10, for the third display mode, in the screen tiling state, the first display panel, the second display panel and the third display panel can be configured to display different areas of the image synergistically. For example, the first display panel can display a first area of the image, the second display panel can display a second area of the image, and the third display panel can display the remaining area of the image. In the third display mode, the first display panel, the second display panel and the third display panel are extended into a display screen nearly 3 times the size by stretching out, and the screen expansion rate is close to 300%. The first display panel, the second display panel and the third display panel work synergistically, and the display chip outputs partial image information A′, B′ and C′ to the first display panel, the second display panel and the third display panel by an algorithm process, respectively. By splicing the partial screen image information A′, B′ and C′ to display the complete image, the display panel size Z (A′, B′, C′) being greater than a size of a single display panel Z (A) is implemented, thereby realizing screen expansion. Therefore, the third display mode can be called an extended display mode.

Compared with current screen expansion methods of electronic devices that utilizes flexible screens to achieve folding screens, scrolling screens, telescopic screens, etc., the screen expansion method according to example embodiments can achieve screen expansion by using conventional screens, thus reducing the dependence on materials and technologies of flexible screen, reducing costs, and enhancing the display effect.

The electronic device 100 may include processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, a programmable logic unit, a microprocessor, application-specific integrated circuit (ASIC), etc. The processing circuitry may include a memory such as a volatile memory device (e.g., SRAM, DRAM, SDRAM) and/or a non-volatile memory (e.g., flash memory device, phase-change memory, ferroelectric memory device). The memory may store a preset program and/or instructions, that when executed by the processing circuitry, configure the processing circuitry as special-purpose processing circuitry for controlling operations of the electronic device 100 described herein, such as controlling the motor 134 and expansion mechanism 130 to switch the plurality of display panels 110 to the screen stacking state or screen tiling state of according to a preset program or user instructions, controlling the power supplied by the motor 134, controlling the display modes using the display panels 111-113 during the screen stacking state and the screen tiling state, and performing other functions of the electronic device 100 described herein.

While inventive concepts have been particularly shown and described with reference to example embodiments, it will be understood by those skilled in the art that various changes in form and details may be made therein without departing from the spirit and scope of inventive concepts defined by the claims.

What is claimed is:

1. An electronic device, including:
a first display panel;
a second display panel;
a third display panel;
a frame, the frame supporting the first display panel, the second display panel, and the third display panel; and
an expansion mechanism, the expansion mechanism connected to the frame,
the expansion mechanism being configured to drive the first display panel and the second display panel to move in a first direction, such that the first display panel, the second display panel and the third display panel switch between a screen stacking state and a screen tiling state,
wherein, in the screen tiling state, the first display panel, the second display panel, and the third display panel are arranged side by side in the first direction and the third display panel is between the first display panel and the second display panel,
wherein, in the screen stacking state, the first display panel, the second display panel, and the third display panel are stacked in a second direction different from the first direction,
wherein the expansion mechanism is configured to control the first display panel, the second display panel and the third display panel to switch between the screen stacking state and the screen tiling state.

2. The electronic device of claim 1, wherein
the first direction corresponds to a width direction of the first display panel or a length direction of the first display panel, the second display panel, and the third display panel, and
the second direction corresponds to a thickness direction of the first display panel, the second display panel, and the third display panel.

3. The electronic device of claim 1, wherein
the frame includes a base frame,
the base frame supports the first display panel, the second display panel, the third display panel and the expansion mechanism,
the base frame slidably supports the first display panel and the second display panel such that the first display panel and the second display panel are able to be moved in the first direction,
the base frame is configured to provide fixed support to the third display panel such that a position of the third display panel relative to the base frame remains unchanged when the first display panel, the second display panel, and the third display panel switch between the screen stacking state and the screen tiling state.

4. The electronic device of claim 3, wherein
the frame further comprises a side frame,
the side frame is mounted on the base frame, and
the first display panel and the second display panel are fixed to the side frame.

5. The electronic device of claim 4, wherein
the base frame comprises a guide groove, and
the side frame is embedded in the guide groove such that the first display panel and the second display panel, which are fixed to the side frame, are configured to be moved in the first direction under a guidance of the guide groove.

6. The electronic device of claim 1, wherein
the expansion mechanism comprises a guide rail, a plurality of sliders, a plurality of connecting rods, and a motor,
the guide rail is on a back of the third display panel,
the guide rail extends in a third direction,
the third direction is perpendicular to the first direction and the second direction;
the plurality of sliders are in the guide rail and configured to be able to slide along the guide rail;
the plurality of connecting rods connect the first display panel and the second display panel to the plurality of sliders; and
the motor is configured to supply power,
wherein, when the plurality of sliders slide along the guide rail in response to the power supplied by the motor, the first display panel and the second display panel move in reverse with each other in the first direction.

7. The electronic device of claim 6, wherein
the plurality of sliders include a first slider and a second slider,
the plurality of connecting rods include a first connecting rod, a second connecting rod, a third connecting rod, and a fourth connecting rod,
the first connecting rod is between the first display panel and the first slider,
the second connecting rod is between the second display panel and the first slider,
the third connecting rod is between the first display panel and the second slider,
the fourth connecting rod is between the second display panel and the second slider.

8. The electronic device of claim 7, wherein
the motor is configured to supply power to the first slider and the second slider to move the first slider and the second slider away from each other,
when the motor moves the first slider and the second slider away from each other, the first display panel and the second display panel move in reverse to each other in the first direction and away from the third display panel, such that an overlap area of the first display panel, the second display panel, and the third display panel in the second direction is reduced,
the motor is configured to supply the power to the first slider and the second slider to move the first slider and the second slider close to each other,
when the motor moves the first slider and the second slider close to each other, the first display panel and the second display panel move in reverse to each other in the first direction and are close to the third display panel, such that the overlap area increases among the first display panel, the second display panel, and the third display panel in the second direction.

9. The electronic device of claim 6, wherein
the motor is a linear motor,
the linear motor is fixed to the frame, and
an output end of the linear motor is connected to the plurality of sliders to supply the power to the plurality of sliders.

10. The electronic device of claim 1,
wherein in the screen tiling state, the first display panel, the second display panel and the third display panel are configured to synergistically display different areas of an image, and
wherein, in the screen stacking state, one of the first display panel, the second display panel and the third display panel is configured to display the image alone, and a remaining two of the first display panel, the second display panel and the third display panel are configured not to display the image, or
wherein, in the screen stacking state,
the first display panel, the second display panel, and the third display panel are configured to synergistically display different partial source information of the image at full resolution and full color by means of dividing layers or color gradation,
the first display panel, the second display panel, and the third display panel are configured to perform asynchronous processing on at least one of pixels and refresh rates of the first display panel, the second display panel, and the third display panel in temporal or spatially scale, and
an uppermost two display panels in the first display panel, the second display panel, and the third display panel are transparent display panels.
